(19) United States
(12) Patent Application Publication
(10) Pub. No.: US 2002/0023714 A1
(43) Pub. Date: Feb. 28, 2002

(54) Adhesive backed photographic paper

(76) Inventor: Howard Huth, Yonkers, NY (US)

Correspondence Address: Matthew J. Peirce, Esq., 1550 Starlight Canyon Avenue, Las Vegas, NV, 89123, US

(21) Appl. No.: 09/938,917

(22) Filed: Aug. 25, 2001

Related U.S. Application Data
(60) Provisional application No. 60/228,376, filed on Aug. 28, 2000.

(51) Int. Cl. B32B 31/00

(52) U.S. Cl. 156/289

(57) ABSTRACT

A new and improved use for adhesive material is disclosed in which the adhesive material would be applied to the back surface of photograph prints for mounting on surfaces. On each photographic print, two different types of adhesive areas would be utilized, with these two different types of adhesives being a permanent adhesive area and a removable adhesive area. The permanent adhesive area would generally surround the perimeter of the back surface of each photographic print and would be approximately ½ inch in diameter. The removable adhesive area would cover the remaining portion of the back surface of a photographic print and would have approximately the same amount of adhesiveness as that of a Post-It™ Note. By only using the removable adhesive area, a user could attach, detach, and reattach a particular photographic print many times. When first developed, both the permanent adhesive area and the removable adhesive area would be covered by a covering which would have peel tabs which a user could pull up to remove the coverings.

### BACKGROUND OF THE INVENTION

The present invention concerns that of a new and improved use for adhesive material in which the adhesive material would be applied to the back surface of photograph prints for mounting on surfaces.

### DESCRIPTION OF THE PRIOR ART

U.S. Pat. No. 5,575,574, issued to Mertens, discloses a sheet composite adapted to be printed in printers of the type commonly used with personal or other types of computers including laser printers, ink jet printers and impact printers.

U.S. Pat. No. 4,507,166, issued to Posner, discloses a method of manufacturing adhesive backed photographs attached to an easily removable non-sticking backing sheet.

U.S. Pat. No. 4,237,206, issued to Fujita, discloses in a photographic paper to be attached to the surface of a desired object, a white adhesive layer, a resin layer containing a light reflective material and an emulsion layer on which an image is to formed are laminated, in that order.

### SUMMARY OF THE INVENTION

The present invention concerns that of a new and improved use for adhesive material in which the adhesive material would be applied to the back surface of photograph prints for mounting on surfaces. On each photographic print, two different types of adhesive areas would be utilized, with these two different types of adhesives being a permanent adhesive area and a removable adhesive area. The permanent adhesive area would generally surround the perimeter of the back surface of each photographic print and would be approximately ½ inch in diameter. The removable adhesive area would cover the remaining portion of the back surface of a photographic print and would have approximately the same amount of adhesiveness as that of a Post-It™ Note. By only using the removable adhesive area, a user could attach, detach, and reattach a particular photographic print many times. When first developed, both the permanent adhesive area and the removable adhesive area would be covered by a covering which would have peel tabs which a user could pull up to remove the coverings.

There has thus been outlined, rather broadly, the more important features of a new and improved use for adhesive material in order that the detailed description thereof that follows may be better understood and in order that the present contribution to the art may be better appreciated. There are, of course, additional features of the new and improved use for adhesive material that will be described hereinafter and which will form the subject matter of the claims appended hereto.

In this respect, before explaining at least one embodiment of the new and improved use for adhesive material in detail, it is to be understood that the new and improved use for adhesive material is not limited in its application to the details of construction and to the arrangements of the components set forth in the following description or illustrated in the drawings. The new and improved use for adhesive material is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present new and improved use for adhesive material. It is important, therefore, that the claims be regard as including such equivalent constructions insofar as they do not depart from the spirit and scope of the present invention.

It is therefore an object of the present invention to provide a new and improved use for adhesive material which has all of the advantages of the prior art and none of the disadvantages.

It is another object of the present invention to provide a new and improved use for adhesive material which may be easily and efficiently manufactured and marketed.

It is another object of the present invention to provide a new and improved use for adhesive material which is of durable and reliable construction.

It is yet another object of the present invention to provide a new and improved use for adhesive material which is economically affordable and available to the buying public.

It is yet another object of the present invention to provide a new and improved use for adhesive material which provides additional benefits not present in the prior art.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a front view of the configuration of the permanent adhesive area and the removable adhesive area on the back surface of a POLAROID-type photographic print.

FIG. 2 shows a front view of the configuration of the permanent adhesive area and the removable adhesive area on the back surface of a standard photographic print.

### DESCRIPTION OF THE PREFERRED EMBODIMENT

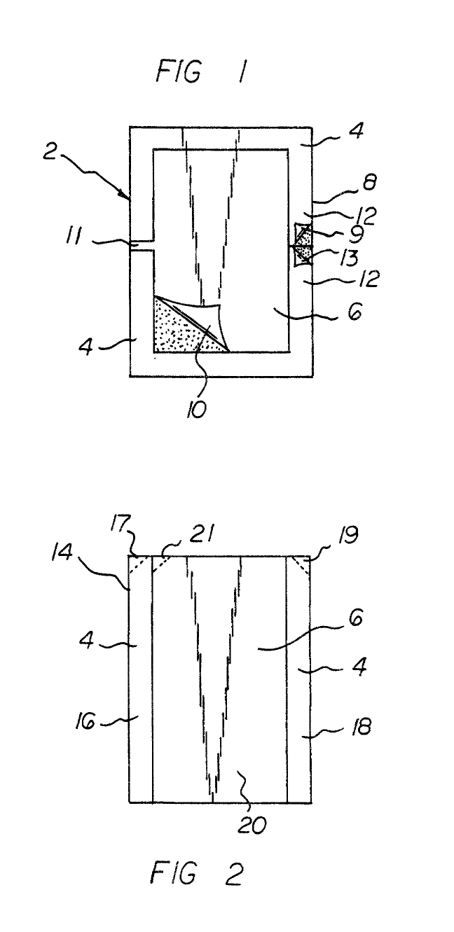

FIG. 1 shows a front view of the configuration of the permanent adhesive area and the removable adhesive area on the back surface of a POLAROlD-type photographic print 2. On each photographic print 2, two different types of adhesive areas would be utilized, with these two different types of adhesives being a permanent adhesive area 4 and a removable adhesive area 6. The permanent adhesive area 4 would generally surround the perimeter 8 of the back surface of each photographic print and would be approximately ½ inch in diameter, except for a small portion in which the peel tab 10 for the permanent adhesive area 4 would be located. The removable adhesive area 6 would cover the remaining portion of the back surface of a photographic print and would have approximately the same amount of adhesiveness as that of a Post-It™ Note.

If a user chose to use only the removable adhesive area, a user could attach, detach, and reattach a particular photographic print many times. When a photographic print 2 would first be placed on the front surface of a photographic print with the type of backing present in the present invention, both the permanent adhesive area 4 and the removable adhesive area 6 would have coverings 10 and 12, respectively, which would protect the adhesiveness and stickiness of both permanent adhesive area 4 and the removable adhesive area 6 until a user would wish to affix a photographic print 2 of the present invention. Covering 10 would have peel tab 11 and covering 12 would have peel tabs 9 and 13, which would allow a user to easily remove either or both covering 10 and covering 12.

FIG. 2 shows a front view of the configuration of the permanent adhesive area 4 and the removable adhesive area 6 on the back surface of a standard photographic print 14. The configuration and placement of both permanent adhesive area 4 and the removable adhesive area 6 are slightly different than photographic print 2. In standard photographic print 14, permanent adhesive area 4 would be located only in two strips which would run lengthwise down both sides of the back surface of standard photographic print 14. Permanent adhesive area 4 would not surround the entire perimeter of the back surface of standard photographic print 14.

On standard photographic print 14, removable adhesive area 6 would cover the remaining portion of the back surface of standard photographic print 14. Coverings 16 and 18 would cover permanent adhesive area 4 on standard photographic print 14, while covering 20 would cover removable adhesive area 6. A user could remove coverings 16 and 18 by removing tabs 17 and 19, while a user would remove covering 20 by removing peel tab 21.

When using the present invention, either or both of the types of adhesive areas could be used. However, once the permanent adhesive area 4 would be used, it might be much harder for a user to remove a photographic print from a particular location, especially after it has been placed in one spot for a particular length of time, which would allow the permanent adhesive area 4 to set in.

What I claim as my invention is:

1. A photographic print having at least four sides comprising:
(a) a front surface, the front surface including a photographic print,
(b) a rear surface including two types of adhesive material, a removable adhesive and a permanent adhesive, the permanent adhesive material being attached to the rear surface along the perimeter of at least two sides, the permanent adhesive preferably having a width of approximately one-half inch along the sides on which the permanent adhesive would be located, the removable adhesive being attached to the rear surface in the area not covered by the permanent adhesive,
(c) a first covering designed to cover the area occupied by the removable adhesive, and
(d) a second covering designed to cover the area occupied by the permanent adhesive.

2. A photographic print having at least four sides according to claim 1 wherein the permanent adhesive material would be attached to the rear surface along the perimeter of at least four sides, the permanent adhesive preferably having a width of approximately one-half inch along the sides on which the permanent adhesive would be located.

3. A photographic print having at least four sides according to claim 2 wherein the first covering further comprises a peel tab for assisting a user in removal of the first covering.

4. A photographic print having at least four sides according to claim 2 wherein the second covering further comprises a pair of peel tabs for assisting a user in removal of the second covering.

5. The process of removably attaching the photographic print having at least four sides to a flat surface comprising the steps of:
(a) removing the first covering from the rear surface of the photographic print, and
(b) applying the rear surface of the photographic print to a flat surface.

6. The process of fixedly attaching the photographic print having at least four sides to a flat surface comprising the steps of:
(a) removing the first covering from the rear surface of the photographic print,
(b) removing the second covering from the rear surface of the photographic print, and
(c) applying the rear surface of the photographic print to a flat surface.
